(19) United States
(12) Patent Application Publication
(10) Pub. No.: US 2008/0189738 A1
(43) Pub. Date: Aug. 7, 2008

(54) ACTIVE CHANNEL FOR INTERACTIVE TELEVISION SERVICES

(76) Inventors: Richard F. Purpura, Orange, CA (US); Robert G. Arsenault, Redondo Beach, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(21) Appl. No.: 11/959,097

(22) Filed: Dec. 18, 2007

Related U.S. Application Data
(60) Provisional application No. 60/875,710, filed on Dec. 18, 2006.

(51) Int. Cl. H04N 5/445

(52) U.S. Cl. 725/38

(57) ABSTRACT

An interactive home video channel displayed on a monitor is disclosed. A channel in accordance with the present invention comprises a plurality of video cells presenting at least video information, a text box, a menu comprising menu choices, each menu choice and each video cell associated with a programming subject, and a cursor, which can be moved between the plurality of video cells and the menu, for selecting at least one of the video cells and the menu choices, which, presents additional information about the programming subject associated with the selected video cell or menu choice upon selection with the cursor.

### CROSS-REFERENCE TO RELATED APPLICATIONS

This application claims the benefit under 35 U.S.C Section 119(e) of U.S. Provisional Application Ser. No. 60/875,710, filed on Dec. 18, 2006, by Richard F. Purpura et al., entitled “ACTIVE CHANNEL FOR INTERACTIVE TELEVISION SERVICES,” which application is incorporated by reference herein.

### BACKGROUND OF THE INVENTION

1. Field of the Invention

The present invention relates generally to satellite video systems, and in particular, to a method, apparatus, and article of manufacture for interactive mosaic channel video streams with barker channels and guides.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location.

Satellite uplink signals 116 are transmitted by one or more uplink facilities 118 to the satellites 102-104 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz. Future satellites will likely broadcast in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses an interactive home video channel displayed on a video monitor. A video channel in accordance with the present invention comprises a plurality of video cells presenting at least video information, a text box, a menu comprising menu choices, each menu choice and each video cell associated with a programming subject, and a cursor, which can be moved between the plurality of video cells and the menu, for selecting at least one of the video cells and the menu choices, which, presents additional information about the programming subject associated with the selected video cell or menu choice upon selection with the cursor.

The channel optionally includes a barker cell presenting additional video and audio information, wherein the barker cell is selectable by the cursor, a subordinate screen, displayed on the video monitor, for presenting the additional information, the subordinate screen being selected from a group comprising a weather screen, a mix channels screen, a best bets screen, a horoscope screen, and a lottery screen, and, when the subordinate screen is displayed, barker cell information presented on the subordinate screen is related to the programming subject associated with the subordinate screen.

Such a channel further optionally includes information presented in the text box changing when the cursor is moved, the interactive home video channel being displayed on a monitor when the monitor is initially powered, at least one of the video cells is used for ordering pay-per-view programming, ordering satellite television services, or for advertising, and can also further comprise an information box. The information presented in the information box can change based on a position of the cursor, or can change based on which subordinate screen is selected. At least one subordinate screen can further comprise a menu and/or a second information box, and information presented in the second information box changes as the cursor is moved through menu choices on the subordinate screen.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2 illustrates a top level channel view in accordance with the present invention; and

FIGS. 3-7 illustrate additional interactive features that are accessible via the present invention.

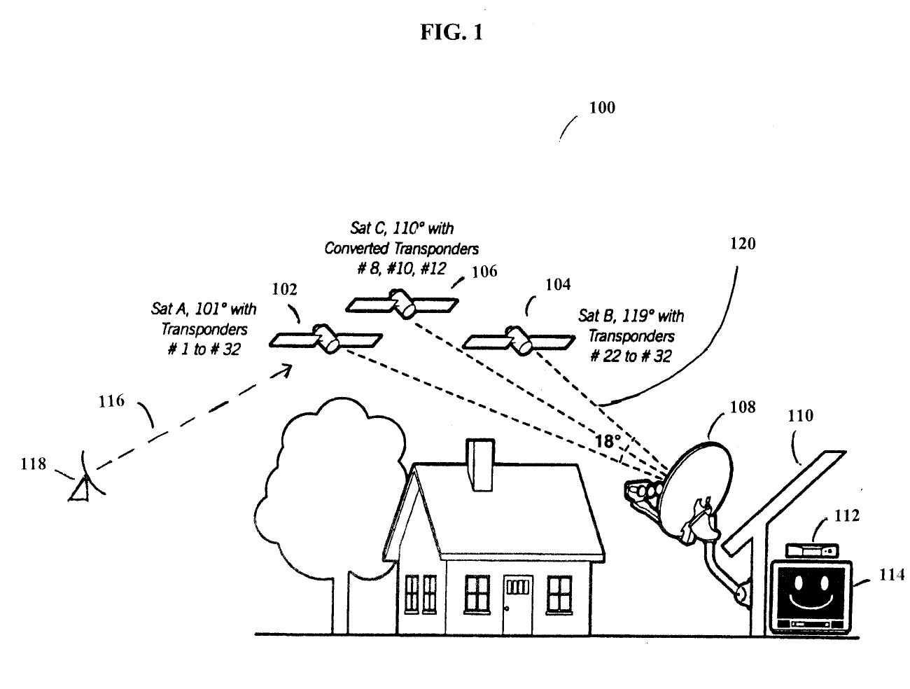

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The present invention is an interactive television channel that allows a viewer to view a video stream and select specific audio and/or video from the video stream based on a viewer's individual desires. The video stream is typically delivered to a user's monitor 114 via system 100, but could be done using cable or other terrestrial techniques.

When a viewer watches a specific program on a monitor 114, they are watching a “viewer channel” that comprises video and audio information that is routed to a specific “channel” to the monitor 114. For example, when a viewer wants to watch the local FOX affiliate station, they know that station is associated with a specific channel number on their monitor 114 or IRD 112, e.g., channel 11. When they program or otherwise indicate to the monitor 114 or IRD 112 to tune to channel 11, the monitor 114 or IRD 112 manipulates the electronics to capture and present the video information associated with that command from the satellite downlink 120, or from another source such as a coaxial cable input (cable TV) or terrestrial broadcast frequencies to present that information on monitor 114. The “viewer channel” information is typically the information that is presented when a viewer selects a given “channel” on the monitor 114 or IRD 112.

The present invention provides for a “home channel” that can be customized by individual viewers to present user-specific and user-selected information on a given viewer channel. The home channel, or “active channel” can be customized by the viewer to be shown when the monitor 114 is initially turned on, as well as having access to the home channel via normal channel selection services.

### Monitor Presentations

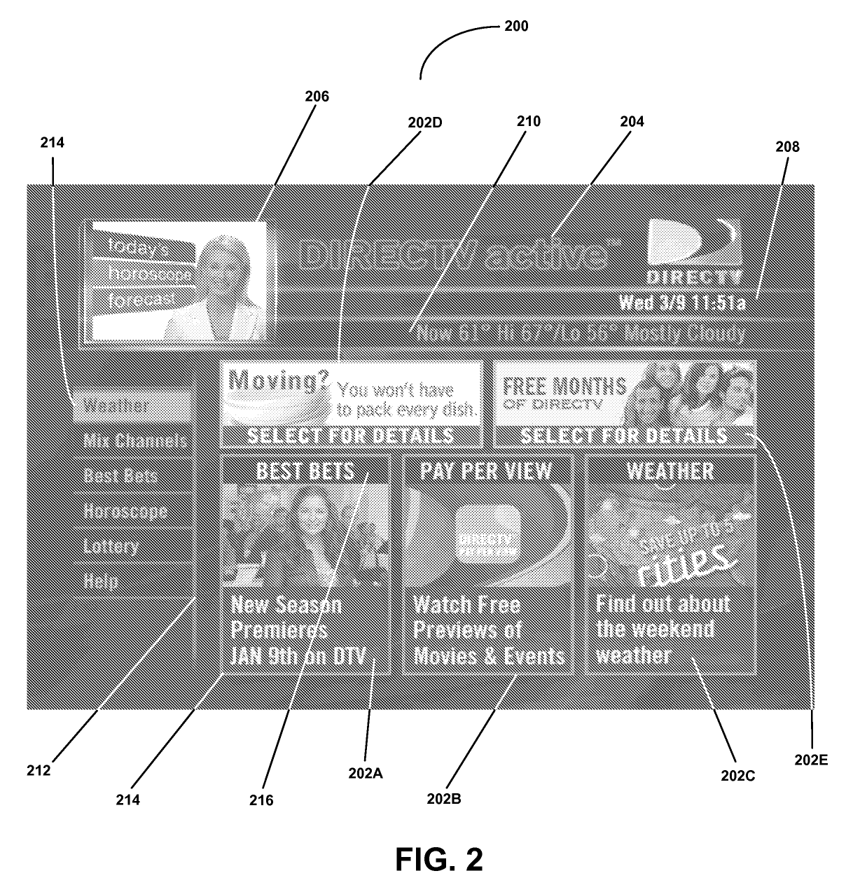

FIG. 2 illustrates a top level channel view in accordance with the present invention.

Screen 200 is typical of the top level of the active channel of the present invention as shown on monitor 114. Such screen 200 typically includes a number of video cells 202A-202E, and a text box 204. Optionally, the interactive mosaic channel 200 further comprises a separate video cell 206, also called a “barker cell” 206, a date/time function 208, a weather function 210, and a menu 212.

The number of video cells 202A-E can change based on the number of video cells 202A-E desired. As the number of video cells 202 increases, of course, there must be a reduction in the size of the video cells 202A-E to ensure that the video cells are differentiated on the monitor 114. As the number of video cells 202 decreases, the size of the video cells 202A-E can increase, since there is more space available on monitor 114 to display video cells 202 A-E. Further, video cells 202A-E do not have to be uniform in size; as shown in FIG. 2, video cells 202D and 202E are smaller than video cells 202A-C. This can be determined by the software in IRD 112, or by viewer preference if desired.

Further, the placement of video cells 202, barker cell 206, text box 204, date/time function 208, a weather function 210, and a menu 212 is not limited to the positions on monitor 114 as shown in FIG. 2. These elements can be displayed anywhere on monitor 114 without departing from the scope of the present invention.

At least some of the program content of the video cells 202A-E are determined by the viewer. For example, one viewer may wish to have screen 200 provide an overview of the “best bets” or favorite programs, what is available on Pay-Per-View (PPV) channels, and the weather forecast for that viewer's region. Such a display of that information is presented in video cells 202A-C, as shown in FIG. 2. However, another user may not want to know what is on PPV channels, and would instead like to have screen 200 show what the current lottery numbers are for their area, and, as such, the present invention allows for manipulation of the information presented on screen 200 which is individualized for each viewer. There can be a standard configuration which is presented upon the first time the screen 200 is visited, and each viewer can customize their screen 200 per their own viewing desires.

The screen 200 also allows for a cursor 214, which is present on either menu 212 or surrounding the video cells 202A-E and/or barker cell 206, to allow the viewer to obtain additional information other than what is presented visually on screen 200. For example, the viewer may use cursor 214 to navigate between screen 200 and other screens associated with screen 200, or may use cursor 214 to select audio presentations that are associated with each of the video cells 202A-E and barker cell 206. With several different audio streams for the various video cells 202A-E, presenting more than one audio stream at a given time may be confusing. As such, it is typical that only one audio stream of information is presented at a given time. Each of the video feeds may also have closed-captioning information associated with it, and selection of a closed-captioned presentation, rather than an audio presentation, can be performed as described herein.

The cursor 214 may also be used to change the video presented in the barker cell 206. For example, by selecting video cell 202A, barker cell 206 may change its' audio and/or video output to match the video information present in video cell 202A.

Video Cells

Video cells 202A-E each comprise a separate viewer choice for programming. Each viewer can select at least one of the video cells 202A-E to allow a viewer to obtain information on the selected genre or subject in a given video cell 202A-E, without sequentially searching through the various viewer channels or referring to a program guide to find which channels are presenting such information.

So for example, the video cells 202A-E can be programmed to present to a viewer, on a single screen 200, a “one-touch” method for finding out what is going on in a given genre or field of interest to that specific viewer. Many viewers are interested in weather, sports, news, current programming on various channels, etc., but to present all of those channels in an interactive mosaic channel would be confusing. Using a guide requires manual intervention by the user to determine which channel a given program is on. Screen 200 of the present invention automates the channel selection, as well as giving viewers information that is not necessarily present on any given viewer channel at any given time.

Video cells 202A-E can also provide for advertisements, or other services where a user is required to interact with IRD 112 via monitor 114. For example, a video cell 202D may be dedicated to ordering PPV shows, or for paying a viewer's satellite TV bill or other bills via electronic bill paying services. A user can select such a video cell 202D using cursor 214, and interact with IRD 112 in a user-friendly manner to perform such services.

The placement and video programming content for each video cell 202 can depend on a wide variety of factors, such as user preference, content within video cell 202D, or other reasons.

Optionally, within each of the video cells 202 is a genre identification (ID) box 216. Typically, the genre ID box 216 indicates to the viewer a moniker or generic name that is associated with the video cell 202A-E, such that the viewer is given visual clues as to what that respective video cell 202 represents. By moving cursor 214 to that video cell 202, the viewer expects more detailed information on the subject identified by genre ID box 216. For example and not by way of limitation, in video cell 202A indicates “Best Bets” in genre ID box 216, which indicates to a viewer that by selecting video cell 202A with cursor 214, the viewer will be given additional information on top-rated programming choices or other programming that is preselected by the user.

Other information may also appear in genre ID box 216, such as an indication that the video feed that is being presented in the associated video cell 202A-E is a “user favorite” channel, the genre ID box 216 may be presented in a different color or video texture to indicate that the video feed that is being presented in the associated video cell 202A-E is a channel that presents programming that adults may wish to block from their children's view or has closed-captioning available, etc. Many possibilities are available within the scope of the present invention to present various types of video information within genre ID box 216 for viewer selection and benefit. The genre ID box 216 may also contain instructions to the viewer depending on what other information is being presented in the associated video cell 202A-E. For example, and not by way of limitation, video cell 202D shows “Select for Details” in genre ID box 216, as an informational aid to the viewer that may be interested in the offer presented in video cell 202D.

Text Box

Text box 204 contains textual information that is useful to the viewer, and this information can change depending on the viewer's selection of interactive services as described herein. For example, the text box 204 can contain a generic statement about the genre of the screen 200, or statements directed to a selected video cell 202A-E when selected by cursor 214. The text box can also scroll to present additional information to the viewer that does not all fit within text box 204 at a given time.

Barker Cell

Barker cell 206 is a presentation of video data that can relate to the video cells 202A-E that are present on screen 200, or elsewhere available via menu 212. For those screens 200 that have the optional barker cell 206, the barker cell 206 can use audio or video clues to direct the user to one of the video cells 202A-E for more information on a given topic, or provide an overview of the information presented within the video cells 202A-E.

Barker cell 206 can present audio and video information that is not available on any other viewer channel that is accessible to IRD 112 or monitor 114, other than within the barker cell 206 of the screen 200. When the barker cell 206 presents audio and video information that is not present on any other viewer channel accessible to IRD 112 or monitor 114, then the barker cell 206 may not have an associated genre ID box 216.

Date/Time Function

Date/time function 208 provides the viewer with the current date and time, which can be adjusted for local time as well as daylight saving time (DST) automatically via IRD 112.

Weather Function

The weather function 210 can be used to provide real-time weather information to a viewer. The weather function 210 can provide current weather, as well as providing visual clues to a viewer if weather is rapidly changing in the viewer's area. For example, weather function 210 can flash, change colors, or provide other graphical clues, or be tied to one of the video cells 202A-E or barker cell 206 to give viewers updates to the weather of interest to a viewer. For example, and not by way of limitation, a viewer may have relatives in another part of the country, and have programmed into their screen 200 that the viewer wants to know if the weather in those parts of the country changes. Weather function 210 can provide these changes to the viewer by flashing, or by otherwise indicating to the user that there is a weather alert in an area of interest.

Menu Functions

Menu 212 allows user to select, using cursor 214, additional information that is being presented in video cells 202A-E, as well as other information that is presented as part of screen 200 that is not available in video cells 202A-E. For example, as shown in FIG. 2, menu 212 allows for a “lottery” selection, that is not shown in any of the video cells 202A-E. Such information can still be accessed by a viewer via screen 200, specifically by menu 212.

### Additional Interactive Features

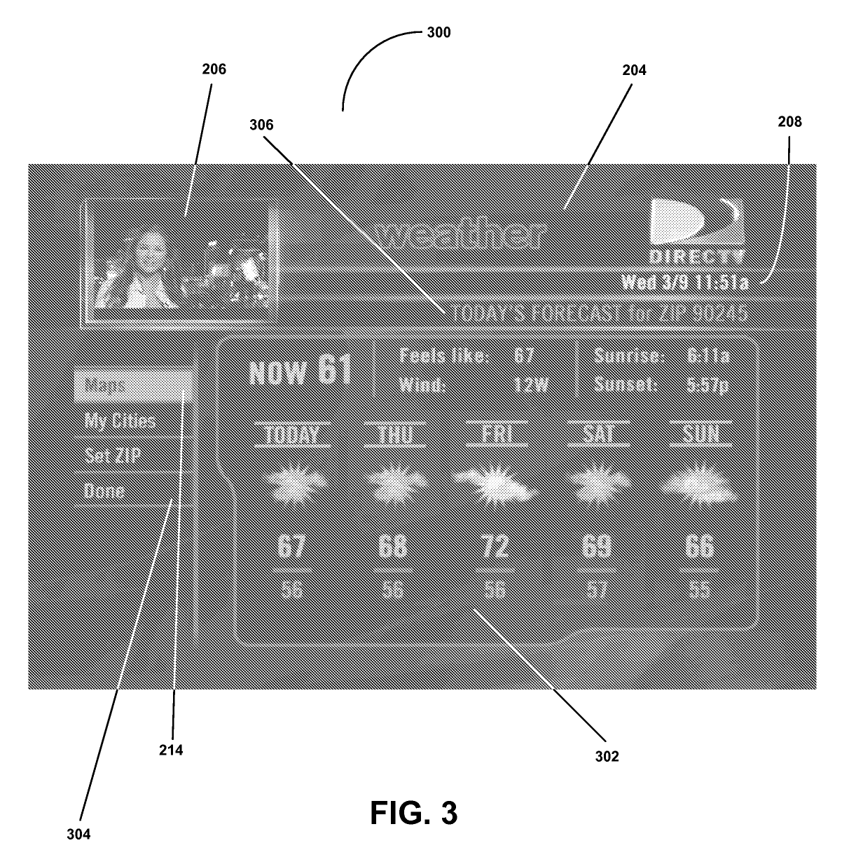

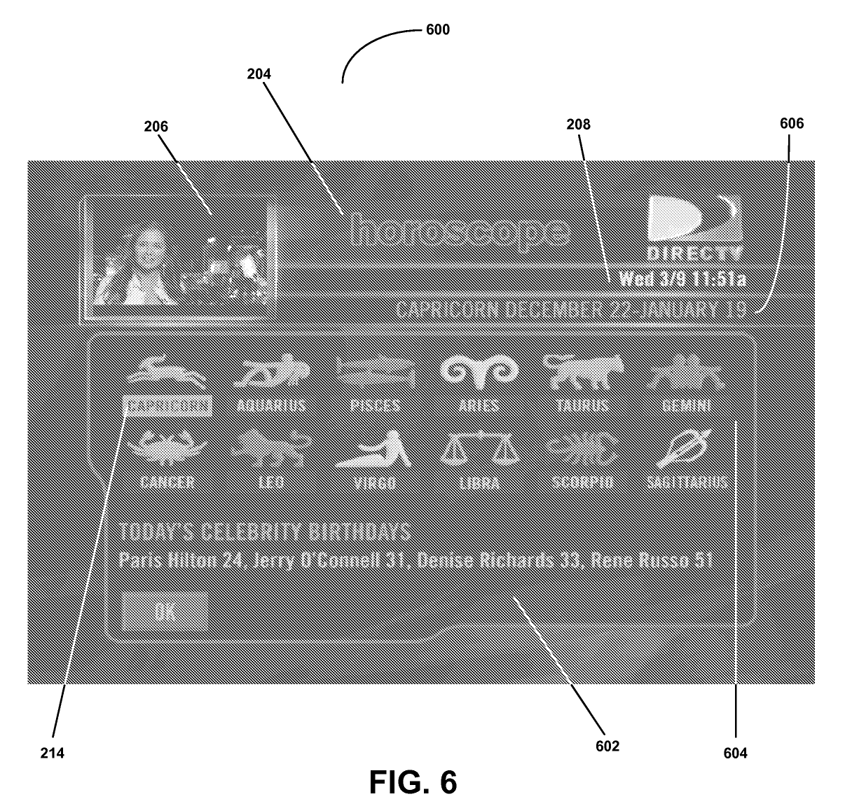

FIGS. 3-7 illustrate additional interactive features that are accessible via the present invention.

### Weather Screen

FIG. 3 illustrates a typical screen 300, which is a weather screen 300, selectable from screen 200, either by moving cursor 214 in menu 212 and selecting the weather selection, or by moving cursor 214 among video cells 202A-E and selecting the weather video cell 202A-E.

Within weather screen 300, some similarities between weather screen 300 and screen 200 exist, such as the presence of a text box 204, date and time function 208, barker cell 206, and cursor 214 are present. Further, additional information, such as video cell 302, menu 304, and information box 306 are also shown.

Barker cell 206 may also comprise different information once weather screen 300 is selected. Barker cell 206 may comprise a video program that is available elsewhere via a viewer channel, e.g., The Weather Channel, or may be a local or regional programming weather video based on information entered in information box 306. Audio associated with the barker cell 206 may be played when weather screen 300 is viewed as desired by the viewer.

Video Cell

Video cell 302 presents information to the viewer that relates to the text box 204 information. In weather screen 300, text box 204 reads, “weather,” indicating that the weather screen 300 will be presenting weather information to the viewer. Video cell 302 shows a five-day forecast, current temperature, and almanac data, for the area indicated in information box 306. Other presentations are possible within video cell 302 without departing from the scope of the present invention.

Menu

Menu 304 allows viewers to select different presentations for video cell 302. For example, a viewer can move cursor 214 to the “Maps” choice on menu 304, and select that choice, which would change video cell 302 presentation to a map rather than a five-day forecast. The map selection may also have a sub-menu that allows for a local map, regional map, national map, or other map presentation, which may also interact with other user-selected parameters such as zip code, time zone, or other information known to IRD 112, to select the map or the map presentation. For example, the information box reads a zip code of 90245, which is in El Segundo, Calif. As such, when the map selection on menu 304 is chosen by the user, a map of Los Angeles may appear, and can appear centered on El Segundo if desired. Other map presentations are possible based on the video content of the map. For example, if a storm is approaching El Segundo when the user selects the Maps choice from menu 304, a different map may be presented that overrides the user's selection, to indicate to the user that the storm is approaching.

Other menu 304 choices are also possible, such as selecting additional cities that a viewer may be interested in, which allows a user to view localized weather conditions in other areas of the world where a viewer has interests. For example, a viewer in Los Angeles may have relatives or friends that live on the East Coast of the United States, or travels to certain locations on a regular basis, and therefore wants to know what the weather is like in those areas, as well as a forecast for upcoming weather. By selecting the “My Cities” selection on menu 304, the user can enter specific zip codes or city names to allow IRD 112 and the present invention to display such information on monitor 114.

Further, viewers can set a zip code for the “home” page of the weather screen 300, such that when the weather screen 300 is selected from screen 200, the weather for the selected zip code will be displayed in video cell 302. When the viewer is finished reviewing the information, the viewer can select “done” which will return the viewer to screen 200.

Information Box

Information box 306 displays information typically related to video cell 302, as shown in FIG. 3. The zip code and “Today's Forecast” are given, to indicate to a viewer that the information shown in video cell 302 is for a certain area and is a forecast for a given time period. Other information may be presented, such as a different zip code, or, if a map view is shown, could indicate that it is a doppler map, an infrared map, pressure map, or other type of map, as well as indicating the source of the information presented.

### Mix Channel Screen

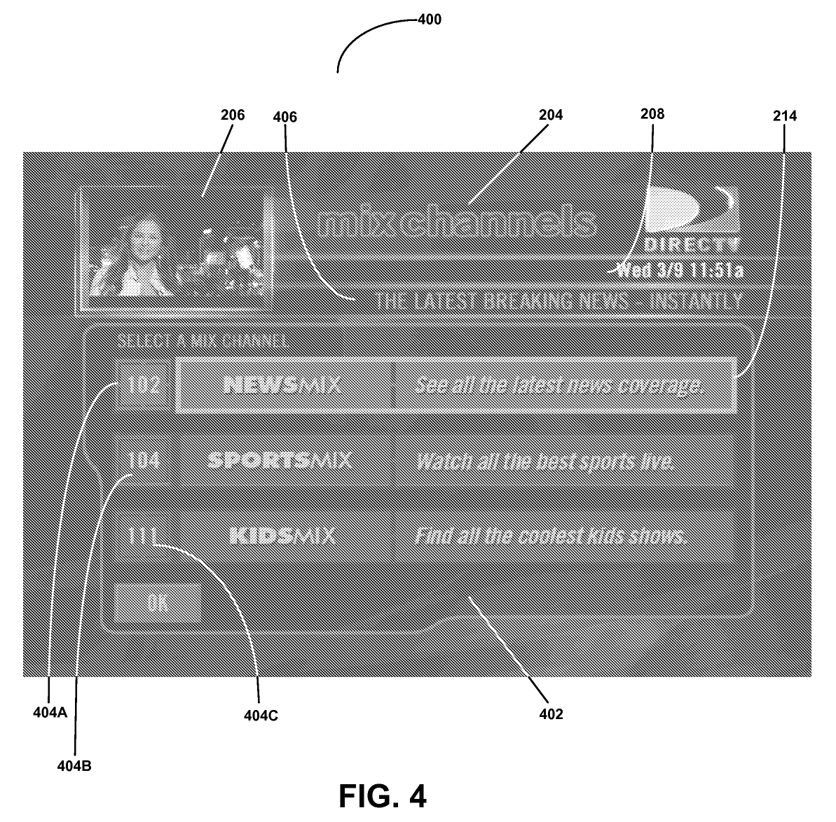

FIG. 4 illustrates a typical screen 400, which is a mix channel screen 400, selectable from screen 200, either by moving cursor 214 in menu 212 and selecting the mix channel selection, or by moving cursor 214 among video cells 202A-E and selecting the mix channel video cell 202A-E.

Within mix channel screen 400, some similarities between mix channel screen 400 and screen 200 exist, such as the presence of a text box 204, date and time function 208, barker cell 206, and cursor 214 are present. Further, additional information, such as video cell 402, channel ID boxes 404A-C, and information box 406 are also shown.

Barker cell 206 may also comprise different information once mix channel screen 400 is selected. Barker cell 206 may comprise a video program that is available elsewhere via a viewer channel, the barker cell associated with a given selected mix channel, or may be a local or regional programming channel video based on other information. Audio associated with the barker cell 206 may be played when mix channel screen 400 is viewed as desired by the viewer.

Video Cell

Video cell 402 presents information to the viewer that relates to the text box 204 information. In mix channel screen 400, text box 204 reads, “mix channels,” indicating that the mix channel screen 400 will be presenting information related to the available mix channels to the viewer. Video cell 402 shows the selections available in mix channel format, along with channel ID boxes 404A-C, to indicate the channel identifications for the various available mix channels. Other presentations are possible within video cell 402 without departing from the scope of the present invention.

As a viewer moves cursor 214 among the mix channels, the barker cell 206 video can change to video and/or audio information related to the selected mix channel.

Channel ID Boxes

The channel ID boxes 404A-C indicate the direct tuning channel number for the related mix channels presented in video cell 402. If desired, a viewer can enter the channel ID number shown in channel ID boxes 404A-C to directly tune to the mix channels if desired, or can move cursor 214 to the desired mix channel and select using a “one-touch” selection method.

Information Box

Information box 406 displays information typically related to video cell 402, as shown in FIG. 4. Since “News Mix” channel is highlighted by cursor 214, information box 406 indicates a message related to that highlight, i.e., that the News Mix provides “The latest breaking news, instantly.” Other information may be presented in information box 406 if desired.

### Best Bets Screen

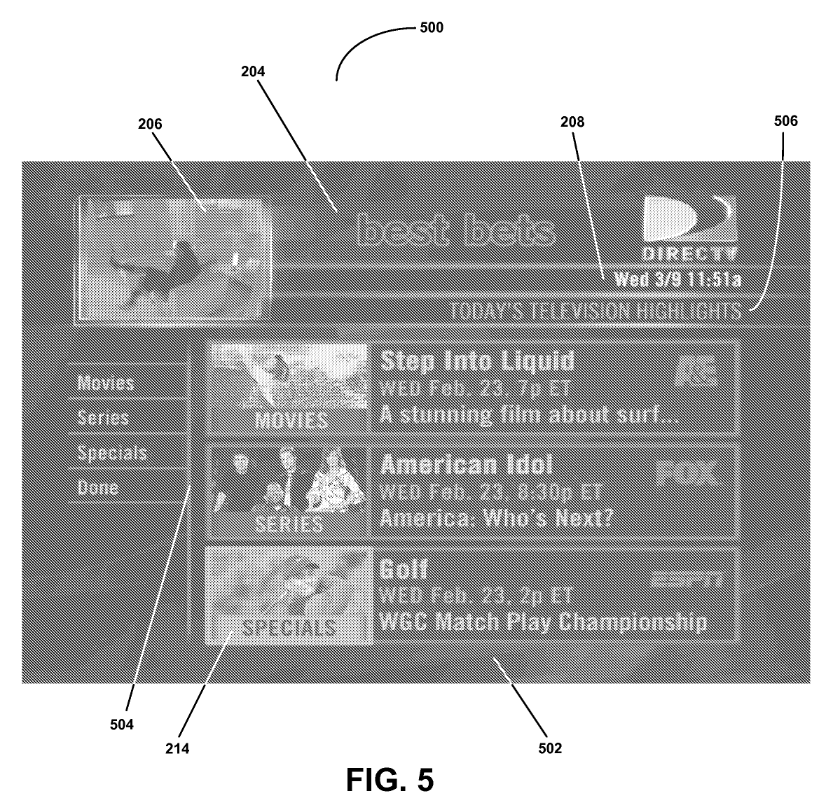

FIG. 5 illustrates a typical screen 500, which is a best bets screen 500, selectable from screen 200, either by moving cursor 214 in menu 212 and selecting the Best Bets selection, or by moving cursor 214 among video cells 202A-E and selecting the Best Bets video cell 202A-E.

Within best bets screen 500, some similarities between best bets screen 500 and screen 200 exist, such as the presence of a text box 204, date and time function 208, barker cell 206, and cursor 214 are present. Further, additional information, such as video cell 502, menu 504, and information box 506 are also shown.

Barker cell 206 may also comprise different information once best bets screen 500 is selected. Barker cell 206 may comprise a video program that is available elsewhere via a viewer channel, or can be a barker cell associated with the best bets feature of the present invention. Audio associated with the barker cell 206 may be played when best bets screen 500 is viewed as desired by the viewer.

Video Cell

Video cell 502 presents information to the viewer that relates to the text box 204 information. In best bets screen 500, text box 204 reads, “best bets,” indicating that the best bets screen 500 will be presenting information related to the most popular programs, movies, and specials available to the viewer. Video cell 502 shows the selections available in the best bets format, e.g., movies, series, and specials, along with menu 504, to indicate to the viewer that sub-selections are available for viewing. Other presentations are possible within video cell 502 without departing from the scope of the present invention.

As a viewer moves cursor 214 among the best bet sub-selections shown in video cell 502, the barker cell 206 video can change to video and/or audio information related to the highlighted sub-selection.

Menu

Menu 504 allows viewers to select different presentations for video cell 502. For example, a viewer can move cursor 214 to the “Movies” choice on menu 504 (or onto the movies portion of video cell 502), and select that choice, which would change video cell 502 presentation to the movies that are being shown in a given time period. Such a selection can be shown on a subordinate screen, and can provide information related to each of the programming selections, such as the title, a plot synopsis, and start and end times, and other information related to the selections presented.

Other menu 504 choices are also possible, such as selecting serial television shows, special presentations, sports programming, or user-defined selections by genre or television show. For example, a user may be interested in a show that is currently being filmed and is also in syndication, and, as such, the program is shown on several different channels throughout the day. A viewer can define their own “best bets” selection, and place those channels that air the viewer favorite program, and select that menu 504 choice with cursor 214. The video and/or guide information about those channels would then be presented to the viewer, either on best bets screen 500 or on a subordinate screen. When the viewer is finished reviewing the information, the viewer can select “done” which will return the viewer to screen 200.

Information Box

Information box 506 displays information typically related to video cell 502, as shown in FIG. 5. The information presented in information box 506 can change depending on the position or location of cursor 214 if desired.

### Lottery Information

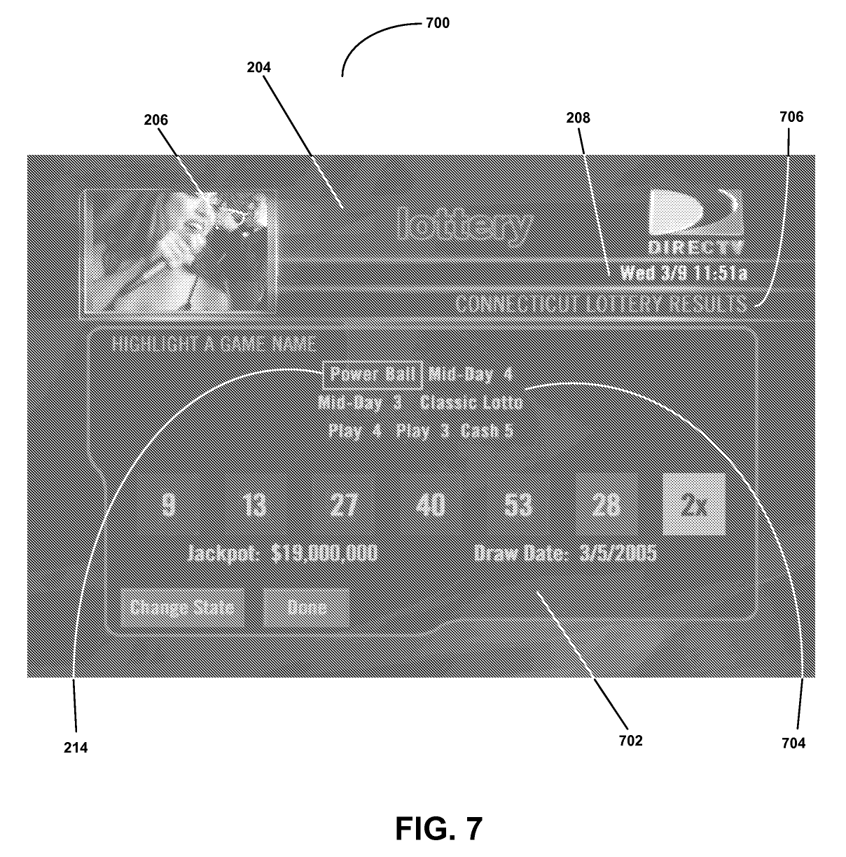

FIG. 7 illustrates a typical screen 700, which is a lottery screen 700, selectable from screen 200, either by moving cursor 214 in menu 212 and selecting the lottery selection, or by moving cursor 214 among video cells 202A-E and selecting the lottery video cell 202A-E.

Within lottery screen 700, some similarities between lottery screen 700 and screen 200 exist, such as the presence of a text box 204, date and time function 208, barker cell 206, and cursor 214 are present. Further, additional information, such as video cell 602, menu 604, and information box 606 are also shown.

Barker cell 206 may also comprise different information once lottery screen 700 is selected. Barker cell 206 may comprise a video program that is available elsewhere via a viewer channel, or can be a barker cell associated with the lottery feature of the present invention. Barker cell 206 is optional and not required for lottery screen 700, but may be provided at certain times, such as when the lottery drawing is taking place, or can be provided as desired. Audio associated with the barker cell 206 may be played when lottery screen 700 is viewed as desired by the viewer.

Video Cell

Video cell 702 presents information to the viewer that relates to the text box 204 information. In horoscope screen 600, text box 204 reads, “lottery,” indicating that the lottery screen 700 will be presenting information related to the daily, weekly, or bi-weekly lottery drawings of various jurisdictions of interest to the viewer. Video cell 702 shows, via menu 704, the various lottery drawings associated with a specific jurisdiction, via both textual and graphical format if desired, to indicate to the viewer that sub-selections are available for viewing. Other presentations are possible within video cell 702 without departing from the scope of the present invention.

As a viewer moves cursor 214 among the menu 604 selections shown in video cell 602, the barker cell 206 video can change to video and/or audio information related to the highlighted sub-selection.

Other information can be shown in video cell 702, such as jackpot amounts, lottery drawing dates, etc., that relate to the highlighted or selected menu 704 item. Further, the viewer can change jurisdictions via the “Change State” selection box, and when the viewer is finished reviewing the information, the viewer can select “OK” which will return the viewer to screen 200.

Information Box

Information box 706 displays information typically related to video cell 602, as shown in FIG. 7. Such information can include the jurisdiction selected, or other information. The information presented in information box 706 can change depending on the position or location of cursor 214 if desired.

### Additional Presentation Issues

Parental controls are applicable to each of the screens 300, 400, 500, 600, and 700, as well as screen 200, if desired. For example, a viewer may wish to limit access to horoscope or lottery information, and, as such, can force IRD 112 to require an access code for those screens 600 and 700. Applicable video and/or audio messages can be inserted into screen 200 or any screen 300, 400, 500, 600, 700, that are blocked to inform the viewer that the screen is blocked.

### CONCLUSION

In summary, the present invention discloses an interactive home video channel displayed on a video monitor. An apparatus in accordance with the present invention comprises a plurality of video cells presenting at least video information, a text box, a menu comprising menu choices, each menu choice and each video cell associated with a programming subject, and a cursor, which can be moved between the plurality of video cells and the menu, for selecting at least one of the video cells and the menu choices, which, presents additional information about the programming subject associated with the selected video cell or menu choice upon selection with the cursor.

The channel optionally includes a barker cell presenting additional video and audio information, wherein the barker cell is selectable by the cursor, a subordinate screen, displayed on the video monitor, for presenting the additional information, the subordinate screen being selected from a group comprising a weather screen, a mix channels screen, a best bets screen, a horoscope screen, and a lottery screen, and, when the subordinate screen is displayed, barker cell information presented on the subordinate screen is related to the programming subject associated with the subordinate screen.

Such a channel further optionally includes information presented in the text box changing when the cursor is moved, the interactive home video channel being displayed on a monitor when the monitor is initially powered, at least one of the video cells is used for ordering pay-per-view programming, ordering satellite television services, or for advertising, and can also further comprise an information box. The information presented in the information box can change based on a position of the cursor, or can change based on which subordinate screen is selected. At least one subordinate screen can further comprise a menu and/or a second information box, and information presented in the second information box changes as the cursor is moved through menu choices on the subordinate screen.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. An interactive home video channel displayed on a video monitor, comprising:
a plurality of video cells presenting at least video information;
a text box;
a menu comprising menu choices, each menu choice and each video cell associated with a programming subject; and
a cursor, which can be moved between the plurality of video cells and the menu, for selecting at least one of the video cells and the menu choices, which, presents additional information about the programming subject associated with the selected video cell or menu choice upon selection with the cursor.

2. The interactive home video channel of claim 1, further comprising a barker cell presenting additional video and audio information, wherein the barker cell is selectable by the cursor.

3. The interactive home video channel of claim 2, further comprising a subordinate screen, displayed on the video monitor, for presenting the additional information.

4. The interactive home video channel of claim 3, wherein the subordinate screen is selected from a group comprising a weather screen, a mix channels screen, a best bets screen, a horoscope screen, and a lottery screen.

5. The interactive home video channel of claim 4, wherein when the subordinate screen is displayed, barker cell information presented on the subordinate screen is related to the programming subject associated with the subordinate screen.

6. The interactive home video channel of claim 5, wherein information presented in the text box changes when the cursor is moved.

7. The interactive home video channel of claim 6, wherein the interactive home video channel is displayed on a monitor when the monitor is initially powered.

8. The interactive home video channel of claim 6, wherein at least one of the video cells is used for ordering pay-per-view programming.

9. The interactive home video channel of claim 6, wherein at least one of the video cells is used for ordering satellite television services.

10. The interactive home video channel of claim 6, wherein at least one of the video cells is used for advertising.

11. The interactive home video channel of claim 6, further comprising an information box.

12. The interactive home video channel of claim 11, wherein information presented in the information box changes based on a position of the cursor.

13. The interactive home video channel of claim 11, wherein information presented in the information box changes based on which subordinate screen is selected.

14. The interactive home video channel of claim 11, wherein at least one subordinate screen further comprises a menu.

15. The interactive home video channel of claim 14, wherein the at least one subordinate screen further comprises a second information box.

16. The interactive home video channel of claim 15, wherein information presented in the second information box changes as the cursor is moved through menu choices on the subordinate screen.
